(19) United States
(12) Patent Application Publication
(10) Pub. No.: US 2013/0275249 A1
(43) Pub. Date: Oct. 17, 2013

(54) BEST PRICE DISCOVERY WITH BUYER COMMITMENT

(71) Applicants: Preston McAfee, San Marino, CA (US); Shanmugasundaram Ravikumar, Sunnyvale, CA (US)

(72) Inventors: Preston McAfee, San Marino, CA (US); Shanmugasundaram Ravikumar, Sunnyvale, CA (US)

(73) Assignee: Yahoo! Inc., Sunnyvale, CA (US)

(21) Appl. No.: 13/445,232

(22) Filed: Apr. 12, 2012

(51) Int. Cl. G06Q 30/06

(52) U.S. Cl. 705/26.1

(57) ABSTRACT

Techniques are provided which allow users to purchase goods or services at a suitable price. A user may specify on a website, a maximum price the user is willing to pay for a product the user desires to purchase. The user may provide a deposit and sellers may be notified of the user's commitment to purchase the product and the maximum price the user is willing to pay for the product. The sellers may be allowed to offer their asking prices to the user if their respective asking prices are less than or equal to the maximum price the user is willing to pay. If none of the sellers, offer asking prices less than the user's maximum price, the deposit may be returned to the user.

### BACKGROUND

With the advent of broadband interne, online shopping has grown in popularity. Traditionally, it is the seller's job to attract buyers and then to complete the sale. Most goods and services sold at retail are done so using a general seller-driven protocol whereby the seller sets a price and the buyer decides whether or not to accept that price. Prices for some goods and services might change frequently, but the buyer must still wait for the seller to offer a price he finds acceptable.

In addition, online shoppers typically search for the best price for the product they're interested in purchasing. However, sellers may be hesitant to offer their absolute best price initially because shoppers may user that price for negotiations with other sellers (e.g., get a price match at a “brick and mortar” retailer).

Accordingly, there is a need for a buyer-driven system capable of being utilized by consumers to communicate their purchasing needs to potential sellers.

### SUMMARY

Some embodiments of the invention provide systems and methods which allow online shoppers to specify a desired price for a product and purchase the product from the seller of their choice. A user may specify the maximum price he is willing to pay for a product that he is ready to purchase. In some embodiments, the user may also be asked to provide a minimum reputation level the sellers must meet or exceed. After specifying the maximum price (and reputation level), the user may be asked to provide a deposit. The deposit may be a predetermined portion of the maximum price specified by the user. Sellers may be notified of the user specified maximum price and the user's commitment to purchase the product. Because the user provided a deposit, sellers may rest assured that the user is serious about making a purchase. Thus, the sellers may be more compelled to provide their absolute best (i.e., lowest) price to the user.

The user may then be presented with each of the sellers' asking prices (each of which is less than or equal to the user specified maximum price) and/or other information regarding each seller and the purchase. The other information may include, for example, the seller's reputation (e.g., presented as a star rating), shipping costs, whether the user will be charged tax, etc. It should be noted that sellers who submit asking prices greater than the user specified maximum price and/or sellers whose reputation level is above the user specified minimum reputation may be filtered out, and their offers may not be presented to the user. In addition, the system may impose a threshold reputation level that all sellers must meet in order to be able to present offers to users. For example, even if a user does not specify a minimum reputation level, sellers with a reputation level of less than 2 stars may be filtered out. The reputation level may correspond with the sellers' reputation levels on third party retailers such as for example, Ebay® or Amazon®.

The user may choose a seller from whom to make a purchase based on the asking price and the other information mentioned above. It should be noted that the user may not necessarily choose the seller with the lowest asking price.

If the user makes a purchase, the user provided deposit may be applied to the purchase price. If the user chooses to not make a purchase, the user's deposit may be forfeited. A portion of the deposit may be provided to the seller with the lowest asking price (seller A in the above example). It should be noted that if no sellers offer asking prices which are less than the user specified maximum price, no offers may be presented to the user, and the deposit may be returned to the user.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

### DETAILED DESCRIPTION

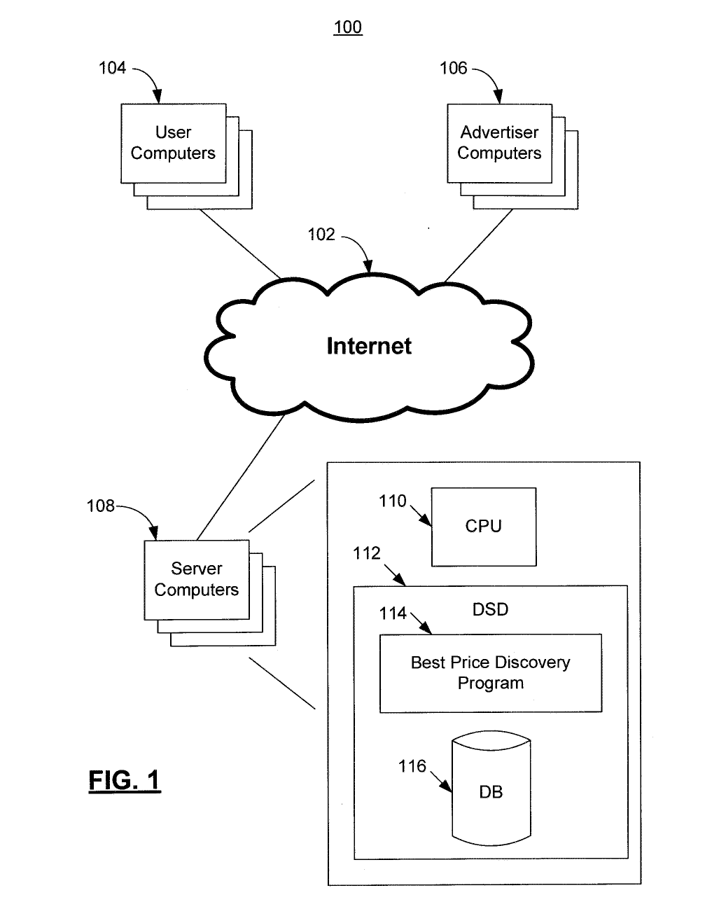

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as smart phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Best Price Discovery Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

Embodiments of the invention allow online shoppers to specify a desired price for a product and purchase the product from the seller of their choice. A user may specify the maximum price he is willing to pay for a product that he is ready to purchase. In some embodiments, the user may also be asked to provide a minimum reputation level the sellers must meet or exceed. After specifying the maximum price (and reputation level), the user may be asked to provide a deposit. The deposit may be a predetermined portion of the maximum price specified by the user. Sellers may be notified of the user specified maximum price and the user's commitment to purchase the product. Because the user provided a deposit, sellers may rest assured that the user is serious about making a purchase. Thus, the sellers may be more compelled to provide their absolute best (i.e., lowest) price to the user.

The user may then be presented with each of the sellers' asking prices (each of which is less than or equal to the user specified maximum price) and/or other information regarding each seller and the purchase. The other information may include, for example, the seller's reputation (e.g., presented as a star rating), shipping costs, whether the user will be charged tax, etc. It should be noted that sellers who submit asking prices greater than the user specified maximum price and/or sellers whose reputation level is above the user specified minimum reputation may be filtered out, and their offers may not be presented to the user. In addition, the system may impose a threshold reputation level that all sellers must meet in order to be able to present offers to users. For example, even if a user does not specify a minimum reputation level, sellers with a reputation level of less than 2 stars may be filtered out. The reputation level may correspond with the sellers' reputation levels on third party retailers such as for example, ebay or Amazon.

The user may choose a seller from whom to make a purchase based on the asking price and the other information mentioned above. It should be noted that the user may not necessarily choose the seller with the lowest asking price. For example, a user interested in purchasing a camera may be presented with offers from sellers. Seller A may have an asking price of $500 plus $50 for shipping. Seller B may have an asking price of $525 with free shipping. Seller C may have an asking price of $575 with free shipping, but with an accessory kit included in the asking price. The user may choose from among sellers A, B, C based on any number of factors. For example, although seller B's asking price is more than seller A's asking price, the final cost will be lower if the user chooses seller B because seller B has included free shipping. Alternatively, if the user is interested in the accessory kit, the user may choose seller C. Or the user may choose seller A because seller A may have the best reputation level. In some embodiments, the user may specify a maximum total price which includes all other costs (e.g., tax, shipping, etc.), and the sellers offers may be filtered accordingly. Using the above example, the user may specify that he wants to purchase a camera for a maximum total price of $550 including tax and shipping. Thus, Seller C's offer may be filtered out, and the user may be presented with offers from Sellers A and B.

If the user makes a purchase, the user provided deposit may be applied to the purchase price. If the user chooses to not make a purchase, the user's deposit may be forfeited. A portion of the deposit may be provided to the seller with the lowest asking price (seller A in the above example). It should be noted that if no sellers offer asking prices which are less than the user specified maximum price, no offers may be presented to the user, and the deposit may be returned to the user.

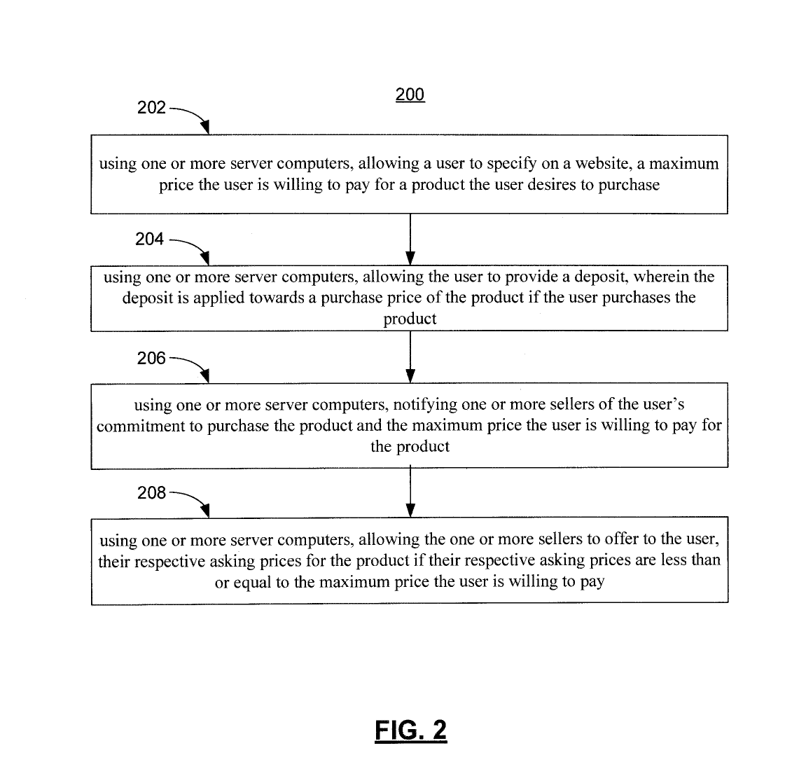

FIG. 2 is a flow diagram illustrating a method 200 according to one embodiment of the invention. At step 202, using one or more server computers, a user may be allowed to specify on a website, a maximum price the user is willing to pay for a product the user desires to purchase. In some embodiments, the user may also specify a minimum reputation level for sellers. The reputation level may correspond with the sellers' reputation on third party retailers such as for example, Ebay® or Amazon®. At step 204, using one or more server computers, the user may be allowed to provide a deposit, wherein the deposit is applied towards a purchase price of the product if the user purchases the product. The deposit may be predetermined portion of the user specified maximum price. The ratio of the deposit to the maximum price may be determined based on for example, variability in the pricing of the product and other economic conditions.

At step 206, using one or more server computers, one or more sellers may be notified of the user's commitment to purchase the product and the maximum price the user is willing to pay for the product. At step 208, using one or more server computers, the one or more sellers may be allowed to offer to the user, their respective asking prices for the product if their respective asking prices are less than or equal to the maximum price the user is willing to pay. In other words, sellers whose asking prices are greater than the user specified maximum price may not be presented to the user. If the user purchases the product from one of the sellers, the deposit may be applied towards the purchase price. If, however, the user does not make a purchase, the deposit may be forfeited. A portion of the deposit may be provided to the seller that offered the lowest asking price for the product. It should be noted that if no sellers offer asking prices which are less than the user specified maximum price, no offers may be presented to the user, and the deposit may be returned to the user.

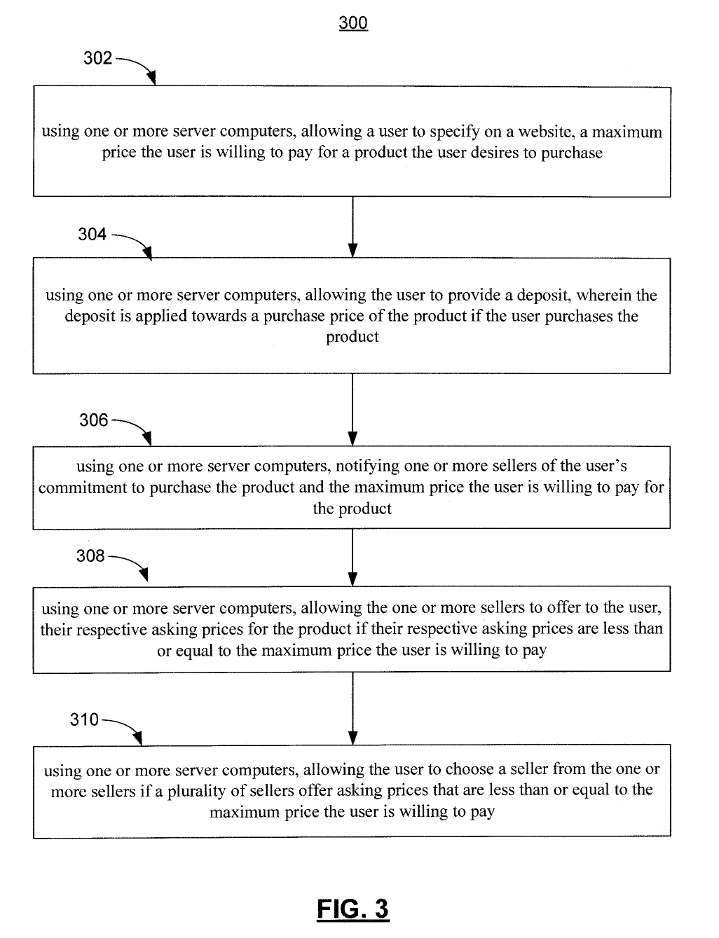

FIG. 3 is a flow diagram illustrating a method 300 according to one embodiment of the invention. At step 302, using one or more server computers, a user may be allowed to specify on a website, a maximum price the user is willing to pay for a product the user desires to purchase. In some embodiments, the user may also specify a minimum reputation level for sellers. The reputation level may correspond with the sellers' reputation on third party retailers such as for example, Ebay® or Amazon®. At step 304, using one or more server computers, the user may be allowed to provide a deposit, wherein the deposit is applied towards a purchase price of the product if the user purchases the product. The deposit may be predetermined portion of the user specified maximum price. The ratio of the deposit to the maximum price may be determined based on for example, variability in the pricing of the product and other economic conditions.

At step 306, using one or more server computers, one or more sellers may be notified of the user's commitment to purchase the product and the maximum price the user is willing to pay for the product. At step 308, using one or more server computers, the one or more sellers may be allowed to offer to the user, their respective asking prices for the product if their respective asking prices are less than or equal to the maximum price the user is willing to pay. In other words, sellers whose asking prices which are greater than the user specified maximum price may not be presented to the user.

At step 310, using one or more server computers, the user may be allowed to choose a seller from the one or more sellers if a plurality of sellers offer asking prices that are less than or equal to the maximum price the user is willing to pay. If the user purchases the product from one of the sellers, the deposit may be applied towards the purchase price. If, however, the user does not make a purchase, the deposit may be forfeited. A portion of the deposit may be provided to the seller that offered the lowest asking price for the product.

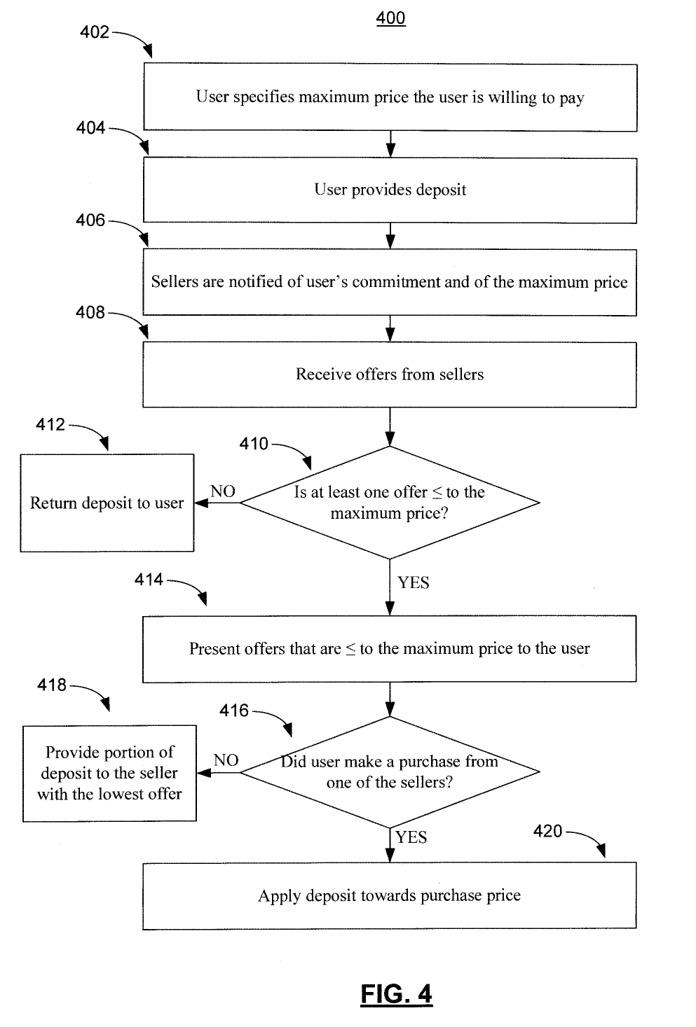

FIG. 4 is a flow diagram illustrating a method 400 according to one embodiment of the invention. At step 402, a user may be allowed to specify on a website, a maximum price the user is willing to pay for a product the user desires to purchase. In some embodiments, the user may also specify a minimum reputation level for sellers. The reputation level may correspond with the sellers' reputation on third party retailers such as for example, Ebay® or Amazon®.

At step 404, the user may be allowed to provide a deposit. The deposit may be held in an escrow account. The deposit may be predetermined portion of the user specified maximum price. The ratio of the deposit to the maximum price may be determined based on for example, variability in the pricing of the product and other economic conditions.

At step 406, one or more sellers may be notified of the user's commitment to purchase the product and the maximum price the user is willing to pay for the product. At step 408, offers may be received from the one or more sellers. At step 410, it is determined if at least one of the offers is less than or equal to the user specified maximum price. If none of the offers are less than or equal to the user's maximum price, the deposit may be returned to the user in step At step 410, it is determined if at least one of the offers is less than or equal to the user specified maximum price. If none of the offers are less than or equal to the user's maximum price, the deposit may be returned to the user in step 412.

At step 414, offers which include asking prices that are less than or equal to the user specified maximum price may be presented to the user. In other words, sellers whose asking prices which are greater than the user specified maximum price may not be presented to the user.

At step 416, it is determined if the user chose one of the offers and made a purchase from the corresponding seller. At step 420, if the user purchased the product from one of the sellers, the deposit may be applied towards the purchase price. If, however, the user does not make a purchase, the deposit may be forfeited. At step 418, a portion of the deposit may be provided to the seller that offered the lowest asking price for the product.

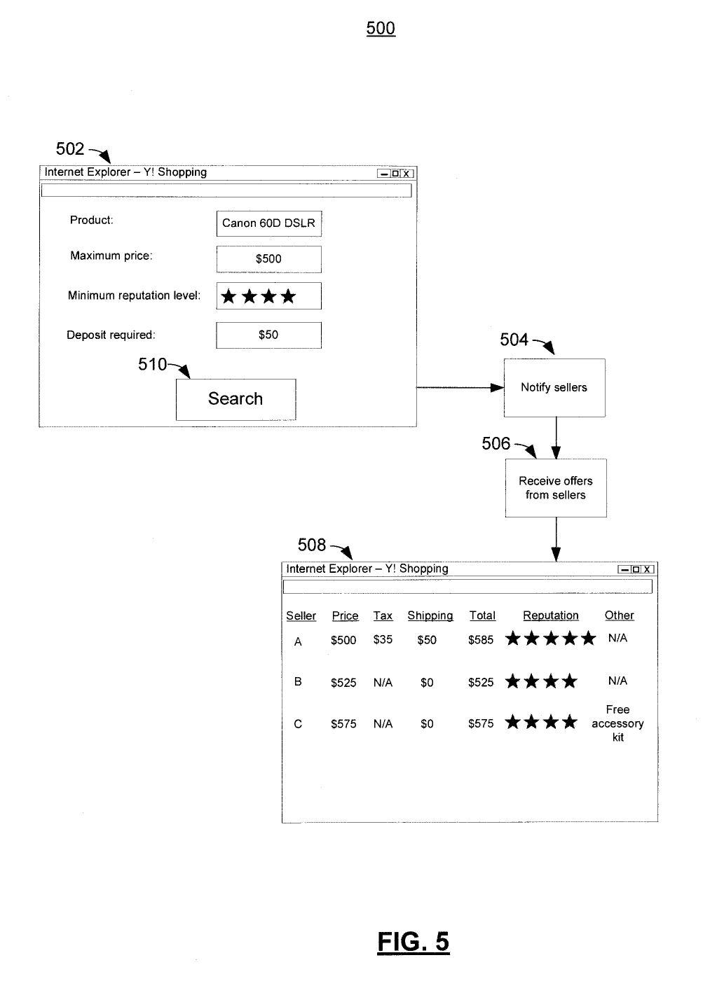

FIG. 5 is a block diagram 500 illustrating one embodiment of the invention. A screenshot of a website 502 in accordance with one embodiment of the invention is depicted. As shown, a user may specify a product, the maximum price the user is willing to pay for the product, and the minimum reputation level of the sellers. Once the user enters the maximum price, a required deposit amount may be displayed to the user. Once the user pays the deposit, the user may search for sellers by clicking search button 510. Sellers may be notified of the user's commitment to purchase the product and the user's maximum price in step 504. Offers may be received from the sellers in step 506. The offers may be presented to the user as shown on website 508. If the user purchases the product from one of the sellers, the deposit may be applied towards the purchase price. If, however, the user does not make a purchase, the deposit may be forfeited. A portion of the deposit may be provided to the seller that offered the lowest asking price for the product. It should be noted that although embodiments were described where a user desires to purchase a product, embodiments of the invention may also be implemented in the purchase of services such as hotel accommodations, airline travel, etc.

While the invention is described with reference to the above drawings, the drawings are intended to be illustrative, and the invention contemplates other embodiments within the spirit of the invention.

1. A method comprising:
using one or more server computers, allowing a user to specify on a website, a maximum price the user is willing to pay for a product the user desires to purchase;
using one or more server computers, allowing the user to provide a deposit, wherein the deposit is applied towards a purchase price of the product if the user purchases the product;
using one or more server computers, notifying one or more sellers of the user's commitment to purchase the product and the maximum price the user is willing to pay for the product; and
using one or more server computers, allowing the one or more sellers to offer to the user, their respective asking prices for the product if their respective asking prices are less than or equal to the maximum price the user is willing to pay.

2. The method of claim 1, further comprising:
providing a portion of the deposit to the seller that offered the lowest asking price if the user does not purchase the product.

3. The method of claim 1, further comprising:
using one or more server computers, allowing the user to specify a minimum reputation level that the one or more sellers must meet or exceed to be allowed to offer their respective asking prices to the user.

4. The method of claim 1, wherein allowing the one or more sellers to offer their respective asking prices to the user further comprises allowing the one or more sellers to offer their respective prices to the user if the one or more sellers meet or exceed a threshold reputation level.

5. The method of claim 1, wherein the deposit is a predetermined percentage of the maximum price the user is willing to pay.

6. The method of claim 5, wherein the predetermined percentage is determined based at least in part on variability in the product's price.

7. The method of claim 1, further comprising:
returning the deposit to the user if none of the respective asking prices of the one or more sellers is less than or equal to the maximum price the user is willing to pay.

8. The method of claim 1, further comprising:
using one or more server computers, allowing the user to choose a seller from the one or more sellers if a plurality of sellers offer asking prices that are less than or equal to the maximum price the user is willing to pay.

9. The method of claim 1, wherein the deposit is held in an escrow account.

10. A system comprising:
one or more server computers coupled to a network; and
one or more databases coupled to the one or more server computers;
wherein the one or more server computers are for:
allowing a user to specify on a website, a maximum price the user is willing to pay for a product the user desires to purchase;
allowing the user to provide a deposit, wherein the deposit is applied towards a purchase price of the product if the user purchases the product;
notifying one or more sellers of the user's commitment to purchase the product and the maximum price the user is willing to pay for the product; and
allowing the one or more sellers to offer to the user, their respective asking prices for the product if their respective asking prices are less than or equal to the maximum price the user is willing to pay.

11. The system of claim 10, wherein the one or more server computers are further configured for:
providing a portion of the deposit to the seller that offered the lowest asking price if the user does not purchase the product.

12. The system of claim 10, wherein the one or more server computers are further configured for:
allowing the user to specify a minimum reputation level that the one or more sellers must meet or exceed to be allowed to offer their respective asking prices to the user.

13. The system of claim 10, wherein allowing the one or more sellers to offer their respective asking prices to the user further comprises allowing the one or more sellers to offer their respective prices to the user if the one or more sellers meet or exceed a threshold reputation level.

14. The system of claim 10, wherein the deposit is a predetermined percentage of the maximum price the user is willing to pay.

15. The system of claim 14, wherein the predetermined percentage is determined based at least in part on variability in the product's price.

16. The system of claim 10, wherein the one or more server computers are further configured for:
returning the deposit to the user if none of the respective asking prices of the one or more sellers is less than or equal to the maximum price the user is willing to pay.

17. The system of claim 10, wherein the one or more server computers are further configured for:
allowing the user to choose a seller from the one or more sellers if a plurality of sellers offer asking prices that are less than or equal to the maximum price the user is willing to pay.

18. The system of claim 10, wherein the deposit is held in an escrow account.

19. The system of claim 12, wherein the reputation level corresponds to the one or more sellers' reputation level on a third party website.

20. A computer readable medium or media containing instructions for executing a method comprising:
using one or more server computers, allowing a user to specify on a website, a maximum price the user is willing to pay for a product the user desires to purchase;
using one or more server computers, allowing the user to provide a deposit, wherein the deposit is applied towards a purchase price of the product if the user purchases the product;
using one or more server computers, notifying one or more sellers of the user's commitment to purchase the product and the maximum price the user is willing to pay for the product;
using one or more server computers, allowing the one or more sellers to offer to the user, their respective asking prices for the product if their respective asking prices are less than or equal to the maximum price the user is willing to pay; and
using one or more server computers, allowing the user to choose a seller from the one or more sellers if a plurality of sellers offer asking prices that are less than or equal to the maximum price the user is willing to pay.
